(19) United States
(12) Patent Application Publication
(10) Pub. No.: US 2024/0211281 A1
(43) Pub. Date: Jun. 27, 2024

(54) LOCK SCREEN INTERFACE MESSAGE PROCESSING METHOD, INTELLIGENT TERMINAL, AND STORAGE MEDIUM

(71) Applicant: HUIZHOU TCL MOBILE COMMUNICATION CO., LTD., Huizhou (CN)

(72) Inventor: Dajian TANG, Huizhou (CN)

(73) Assignee: HUIZHOU TCL MOBILE COMMUNICATION CO., LTD., Huizhou (CN)

(21) Appl. No.: 18/595,448

(22) Filed: Mar. 5, 2024

Related U.S. Application Data
(63) Continuation of application No. PCT/CN2022/117119, filed on Sep. 5, 2022.

(30) Foreign Application Priority Data
Sep. 18, 2021 (CN) 202111097738.0

(51) Int. Cl. G06F 9/451; H04L 51/224

(52) U.S. Cl. CPC G06F 9/451; H04L 51/224

(57) ABSTRACT

This application discloses a lock screen interface message processing method, an intelligent terminal, and a storage medium. The method includes: obtaining one or more unread messages on a mobile terminal; displaying the one or more unread messages on a lock screen interface of the mobile terminal; and after an unlocked state of the mobile terminal is triggered, performing a corresponding response operation on an unread message of the one or more unread messages on the lock screen interface according to an operation instruction.

### CROSS-REFERENCE TO RELATED APPLICATIONS

This application is a continuation of International Application No. PCT/CN2022/117119, filed on Sep. 5, 2022, which claims priority to Chinese Patent Application No. 202111097738.0, filed on Sep. 18, 2021. The disclosures of the above applications are incorporated herein by reference in their entireties.

### TECHNICAL FIELD

The present disclosure relates to message processing technologies, and more particularly, to a lock screen interface message processing method, an intelligent terminal, and a storage medium.

### BACKGROUND

Mobile terminals have become indispensable communication and entertainment tools in people's lives. Configuring the mobile terminals with lock screen functions can enhance the security of the mobile terminals and prevent misoperations caused by accidental touches.

In a lock screen state, a mobile terminal will push received messages on a lock screen interface. To view and reply the message, a user needs to unlock the screen interface and access a notification centre on a desktop of the mobile terminal, or directly open a corresponding application after unlocking the screen interface. However, due to the great variety of application notifications, system notifications, short messages, and social messages as well as the frequently pushed messages, the user needs to frequently unlock the screen interface, access the desktop, view and reply the messages in a drop-down notification, or needs to view and reply the messages after accessing corresponding applications, to view and reply to the messages/notifications, resulting in complex operations, cumbersome processes, and low efficiency.

### SUMMARY

According to an aspect of the present disclosure, a lock screen interface message processing method is provided. The method includes:
obtaining one or more unread messages on a mobile terminal;
displaying the one or more unread messages on a lock screen interface of the mobile terminal; and
performing, after an unlocked state of the mobile terminal is triggered, a corresponding response operation on an unread message of the one or more unread messages on the lock screen interface according to an operation instruction.

According to another aspect of the present disclosure, an intelligent terminal is provided. The intelligent terminal includes a memory, a processor, and a lock screen interface message processing program stored in the memory and executable on the processor, wherein when executed by the processor, the lock screen interface message processing program implements operations of the lock screen interface message processing method as described above.

According to still another aspect of the present disclosure, a non-transitory computer-readable storage medium is provided. The non-transitory computer-readable storage medium stores a lock screen interface message processing program. When executed by a processor, the lock screen interface message processing program implements operations of the lock screen interface message processing method as described above.

### BRIEF DESCRIPTION OF THE DRAWINGS

In order to more clearly illustrate technical solutions in some embodiments of the present disclosure, the drawings needed in description of the embodiments or the prior art will be briefly introduced below. Obviously, the drawings in the following description are only for some embodiments of the present disclosure. For those of ordinary skill in the art, other drawings can be obtained based on these drawings without exerting creative efforts.

FIG. 1 is a schematic flowchart of a lock screen interface message processing method according to some embodiments of the present disclosure.

FIG. 2 is a schematic flowchart for implementing an operation S300 in FIG. 1 in the present disclosure.

FIG. 3 is a schematic flowchart for implementing an operation S400 in FIG. 1 in the present disclosure.

FIG. 4 is a schematic block diagram of a lock screen interface message processing device according to some embodiments of the present disclosure.

FIG. 5 is a schematic block diagram of an internal structure of an intelligent terminal according to some embodiments of the present disclosure.

### DETAILED DESCRIPTION

In the following description, for the purpose of explanation rather than limitation, specific details such as specific system structures and technologies are provided to provide a thorough understanding of the embodiments of the present disclosure. However, it will be apparent to those skilled in the art that the present disclosure may be practiced in other embodiments without these specific details. In other instances, detailed descriptions of well-known systems, devices, circuits, and methods are omitted so as not to obscure the description of the present disclosure with unnecessary details.

It will be understood that, when used in this specification and the appended claims, the term “comprising” indicates the presence of described features, integers, steps, operations, elements and/or components but does not exclude the presence or addition of one or more other features, integers, steps, operations, elements, components, and/or a collection thereof.

It should also be understood that the terminology used in the specification of the present disclosure is for the purpose of describing particular embodiments only and is not intended to be limiting of the present disclosure. As used in this specification and the appended claims, the singular forms “a”, “an” and “the” are intended to include the plural forms unless the context clearly dictates otherwise.

It will be further understood that the term “and/or” as used in this specification and the appended claims refers to and includes any and all possible combinations of one or more of the associated listed items.

As used in this specification and the appended claims, the term “if” may be interpreted as “when”, “once”, “in response to determining”, or “in response to detecting” depending on the context. Similarly, the phrase “if determining” or “if a described condition or event is detected” may be interpreted as “once determining”, “in response to determining”, “once the described condition or event is detected”, or “in response to detecting the described condition or event”.

The technical solutions in the embodiments of the present disclosure are clearly and completely described below with reference to the accompanying drawings of the embodiments of the present disclosure. Obviously, the described embodiments are only some of the embodiments of the present disclosure, rather than all of the embodiments. Based on the embodiments in present disclosure, all other embodiments obtained by those of ordinary skill in the art without creative efforts fall within the scope of protection of present disclosure.

Many specific details are set forth in the following description to fully understand the present disclosure. However, the present disclosure can also be implemented in other ways different from those described here. Those skilled in the art can make similar generalizations without violating the connotation of the present disclosure, and therefore the present disclosure is not limited to the specific embodiments disclosed below.

Mobile terminals have become indispensable communication and entertainment tools in people's lives. Configuring the mobile terminals with lock screen functions can enhance the security of the mobile terminals and prevent misoperations caused by accidental touches. In a lock screen state, a mobile terminal will push received messages on a lock screen interface. To view and reply the message, a user needs to unlock the screen interface and access a notification centre on a desktop of the mobile terminal, or directly open a corresponding application after unlocking the screen interface. However, due to the great variety of application notifications, system notifications, short messages, and social messages as well as the frequently pushed messages, the user needs to frequently unlock the screen interface, access the desktop, view and reply the messages in a drop-down notification, or needs to view and reply the messages after accessing corresponding applications, resulting in complex operations, cumbersome processes, and low efficiency.

In some embodiments of the present disclosure, after one or more unread messages are obtained on a mobile terminal, the one or more unread messages are displayed on a lock screen interface of the mobile terminal, and after an unlocked state of the mobile terminal is triggered, a corresponding response operation is performed on an unread message of the one or more unread messages on the lock screen interface according to an operation instruction. Compared with the existing technology, the solutions in the embodiments of present disclosure display all of the unread message of the mobile terminal on the lock screen interface, and complete the corresponding operation on the unread messages on the current lock screen interface after the unlocked state is triggered. Therefore, the operation is simple and fast, and the unread messages are processed efficiently.

### Exemplary Methods

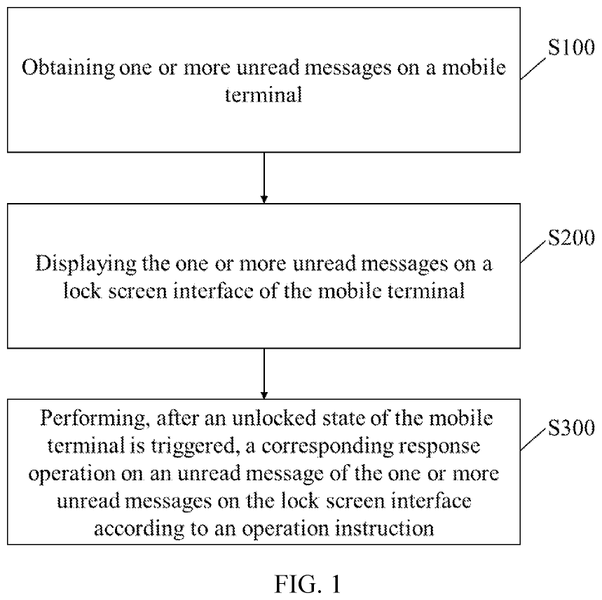

As shown in FIG. 1, some embodiments of the present disclosure provide a lock screen interface message processing method. Specifically, the above method is performed by a processor of the mobile terminal, and includes the following operations S100-S300.

In operation S100, one or more unread messages on a mobile terminal are obtained.

Specifically, the unread messages refer to messages and notifications that have been sent by various applications or the system, previously received or newly received on the mobile terminal, and have not been read by a user. The unread messages include but are not limited to: short messages, system notification messages, third-party social media (e.g., WeChat, QQ, Facebook, Twitter) messages, application notifications and messages, etc.

Furthermore, after the unread messages on the mobile terminal have been obtained, contents of the unread messages, applications that sent the messages, users who sent the messages, and other related information can be read and these messages can be stored in a message dynamic array. According to a preset filtering rule, the messages in the message dynamic array are filtered, and a message that does not meet the filtering rule is removed from the message dynamic array, so that only messages that the user are interested in and cares about are retained in the message dynamic array, which reduces interference caused by redundant messages and spam messages to the user. The filtering rule can be set according to sources of messages, categories of messages, etc., so as to exclude notifications and/or messages from certain applications, messages from certain users and etc. For example, the filtering rule may be set to exclude display of system notifications, messages from a certain WeChat group, messages from entertainment applications such as TikTok, etc.

Optionally, when the mobile terminal is in a lock screen state or a sleep state, it may be detected regularly or irregularly whether any new unread message has been received. When a new unread message has been received, the new unread message may be stored in the message dynamic array. It is also possible that the unread message will not be obtained in the sleep state when the display screen of the mobile terminal is dark, and the message may be obtained when the display screen of the mobile terminal is waked up through the user pressing a power button or clicking the screen of the mobile terminal, which saves power consumption of the mobile terminal.

It should be noted that the mobile terminal can be any device with communication functions, such as, a mobile phone, a tablet, a personal digital assistant, a mobile Internet device, a wearable device, etc.

In operation S200, the one or more unread messages are displayed on a lock screen interface of the mobile terminal.

Specifically, when the mobile terminal is in the lock screen state, the contents of the obtained unread messages on the mobile terminal are read and displayed on the lock screen interface. In order to keep the messages confidential and safe, it may be set that only a small first part of an unread message is displayed in the lock screen state, and the remaining part thereof is represented by an ellipsis.

In some embodiments, a display mode corresponding to an unread message of the one or more unread messages is obtained according to a set display rule, and the unread message is displayed on the lock screen interface according to the display mode. For example, an unread message array is obtained based on the one or more unread messages, and the unread message array may be displayed in a bullet chatting manner on the lock screen interface. There may be a variety of display modes for controlling the display of the messages according to such as movement directions, display array forms, alignment modes, etc. The movement directions may include from top to bottom, from left to right, clockwise, etc. The display array forms may include a rectangle form, a screen edge form, etc. The alignment modes may include aligned mode, misaligned mode, random mode, etc. As another example, the display mode of an unread message may control the display of the message including a movement speed, a movement mode, a display font, a display colour, an avatar of a user who sends the message, a display position etc. of the unread message. By setting the variety of display modes, the user of the mobile terminal may choose a suitable display mode according to the user's own operating habits and browsing habits.

Furthermore, the display rule may include, for example: setting different display fonts and display colours for messages from different applications; displaying different avatars for messages sent by different users; setting different display positions, display colours, movement modes, movement speeds, and the like, for messages from different applications according to the respective usage frequencies of the applications. For example, a content of a message sent by an application that the user uses frequently scrolls slower, and a content of a message sent by an application that the user uses occasionally scrolls faster. The messages may also be categorized as, for example, a work message, an entertainment message, a shopping message, etc., and different display modes may be used for different categories of messages. According to the above display rules, the unread messages are displayed on the lock screen interface in different display modes, so that the user has a clear overview of the messages, and it is convenient for the user to focus more on important message(s).

In operation S300, after an unlocked state of the mobile terminal is triggered, a corresponding response operation is performed on an unread message of the one or more unread messages on the lock screen interface according to an operation instruction (from the user).

Specifically, for the security of the user's information and privacy, the messages displayed on the lock screen interface cannot be operated before the lock screen interface is unlocked. The unlocked state can be triggered by sliding gesture recognition, password recognition, facial recognition, voice recognition, fingerprint recognition, etc. In other words, only after the user is identified as the owner of the mobile terminal, can the user view the details of the messages and notifications, and perform operations such as replying to the messages and identifying the messages.

Optionally, the display mode of the message before unlocking the terminal may be different from the display mode of the message after unlocking the terminal, to realize operational convenience during a message operation. For example, for quick browsing of the messages and depending on personal browsing habits, messages may be displayed in various bullet chatting manners, jump manners, or cartoon manners before unlocking the terminal. After unlocking the terminal, the movement speed of the messages on the lock screen interface is reduced, and the messages are also displayed in a conventional manner such as in a horizontal layout form or a vertical layout form, making it more convenient for the user to select and process the messages. Of course, the displayed content of the message before unlocking the terminal may be different from the displayed content after unlocking the terminal. It is also possible that the displayed content of the message from some application is complete before unlocking the terminal, which may be set depending on the applications that send messages. For example, for a message sent by an entertainment application, if not involving the user's privacy, the entire content of the message can be displayed directly on the lock screen interface in the unlocked state.

When the mobile terminal is in the unlocked state, different operations may be performed on the unread message, such as, viewing the details of the message (or notification), replying to the message, identifying the message, marking the message as read, etc. For example, after the user has clicked the unread message, the message may be displayed as read or an edit box may be displayed for reply to the message directly, or the unread message may be dragged to an edge of the screen to mark the message as read. It should be noted that the operations on the unread message and the corresponding response operations may be diverse and may be changed according to the user's operating habits and the system settings of the mobile terminal. After finishing operating the unread messages, the user may press the power button so that the display of the screen turns off and enters the sleep state, ensuring information security. It is even possible that the current lock screen interface is continuously displayed, thereby continuously displaying unread messages, making it convenient for the user to process unread messages timely.

To sum up, in some embodiments, when the mobile terminal is in the lock screen state, messages and notifications are dynamically displayed, for example in the bullet chatting manner, circularly scrolling on the screen. After identified as the owner of the mobile terminal through a user identity of the system, the user clicks on a message thereof to view and reply and to mark the message as read. The message that has undergone the user's operation will disappear on the lock screen interface. Therefore, in the present disclosure, the user only needs to access the lock screen interface to directly operate the messages. There is no need to switch to various applications or operate in the cramped space of the notification centre. The operations are very simple, and interaction layer is extremely compressed while maintaining the existing interactive operation habits, providing a fast processing solution. The user can not only process the messages efficiently under the premise of ensuring safety, but also choose an appropriate message display mode according to the user's habit, which greatly improves the convenience of use.

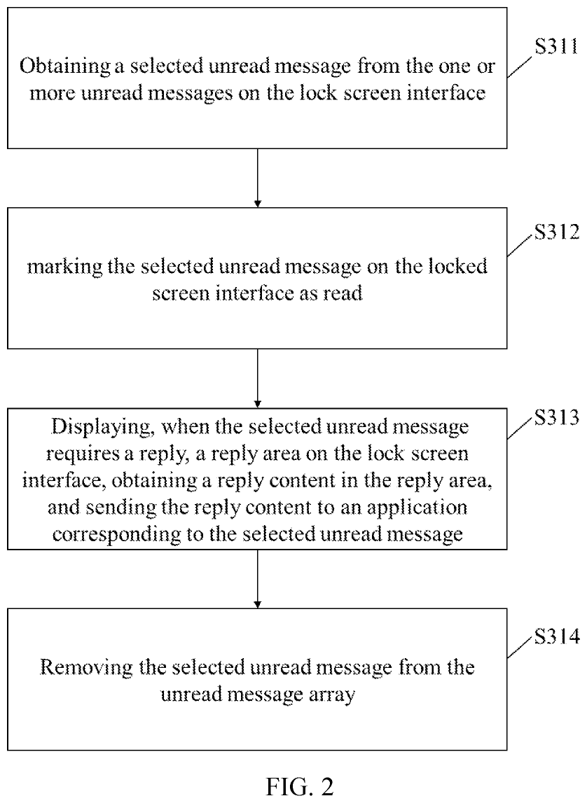

Specifically, in some embodiments, as shown in FIG. 2, the above operation S300 includes the following operations S311-S314.

In operation S311, a selected unread message is obtained from the one or more unread messages on the lock screen interface.

In operation S312, the selected unread message on the lock screen interface is marked as read.

In operation S313, when the selected unread message requires a reply, a reply area is displayed on the lock screen interface, a reply content in the reply area is obtained, and the reply content is sent to an application corresponding to the selected unread message.

In operation S314, the selected unread message is removed from the unread message array.

Specifically, after the unlocked state is triggered, that is, after the current lock screen state of the mobile terminal is unlocked, an unread message that needs to be processed may be clicked or dragged, among the unread messages displayed on the current lock screen interface, to the middle of the lock screen interface, so that the corresponding unread message (i.e., the current unread message) that needs to be processed is selected and marked as read. If only a summary of the current unread message has been displayed, the entire content of the message will be displayed at this time. When the unread message is a social message, such as a message from WeChat, a message from QQ, or a short message sent by a mobile phone contact, a corresponding reply may be made in response to the message. In such case, a translucent window will be displayed below the selected unread message, a reply content may be inputted into the translucent window. After the reply content has been inputted, a sending button is clicked. An application of the unread message may be obtained from the unread message array, and the reply content is sent back to the application, completing the reply. After the reply is completed, since the state of the message has been changed to “read” from “unread”, the message is accordingly removed from the unread message array and will no longer be displayed on the lock screen interface. It should be noted that the unread message may also be replied in other manners, such as with a common voice reply. That is, after the unread message has been selected, a voice input key is pressed to record a voice message to send, so as to complete the voice reply.

By replying to the unread message directly on the lock screen interface, the user can be provided with a solution for high-frequency operation with very few operation steps without changing the existing structure and interaction logic of the existing lock screen interface and desktop. Such quick and easy operations may realize good operating experience and greater operating efficiency.

Specifically, in an application scenario, as shown in FIG. 3, the above operation S300 includes the following operations S321-S322.

In operation S321, a plurality of selected unread messages is obtained from the unread messages on the lock screen interface.

In operation S322, the following operations are performed on the selected unread messages in sequence: marking the plurality of selected unread messages on the lock screen interface as read, and removing the plurality of selected unread messages from the unread message array.

Specifically, after the unlocked state is triggered, that is, after the current lock screen state of the mobile terminal is unlocked, when the unread messages that need to be processed are notification messages, such as system notifications, application notifications, etc., the user can long press one of the unread messages. At this time, the unread messages on the lock screen stop moving and a multi-select function is activated. That is, a gray close icon is displayed at a corner of each unread message displayed on the lock screen interface, and a close button is displayed on the lock screen interface. When one unread message of the unread messages is clicked, the unread message corresponding to the click operation is determined as a selected unread message on the lock screen interface, and the close icon of the unread message becomes coloured. After all unread messages that need to be marked as read have been selected, the close button on the lock screen interface may be clicked to mark these selected unread messages as read all at once and these messages are removed from the unread message array.

In an application scenario, if not interested in a specific content of an unread message, the user can also directly drag the unread message to the edge of the screen or directly click on the close icon on the display box of the unread message, to change the state of the unread message to read. After the state of the unread message is changed to “read”, the message is removed from the unread message array and will no longer be displayed on the lock screen interface.

Operations such as viewing and marking the unread message(s) may be realized through simple operations such as clicking or dragging directly on the lock screen interface, allowing the user to obtain the solution for high-frequency operation with very few operating operation steps, thereby providing a good operating experience and greater operating efficiency.

Therefore, in the embodiments, the message processing methods frequently used by the user is performed through an extremely simplified interaction layer, making the user's operations simple and efficient.

### Exemplary Device

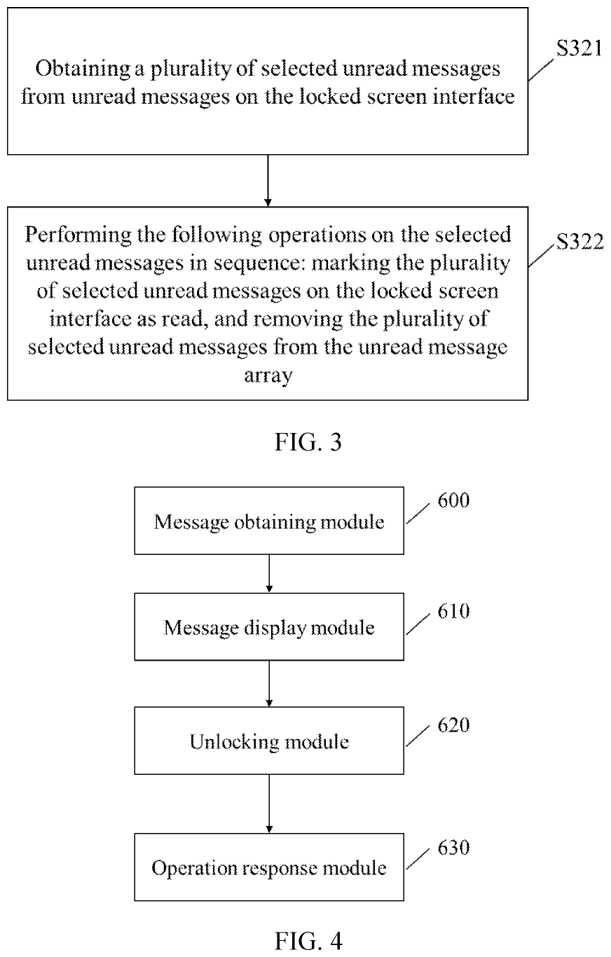

As shown in FIG. 4, corresponding to the above lock screen interface message processing method, some embodiments of the present disclosure further provide a lock screen interface message processing device. The above lock screen interface message processing device includes a message obtaining module 600, a message display module 610, an unlocking module 620, and an operation response module 630.

The message obtaining module 600 is configured to obtain one or more unread messages on a mobile terminal.

Specifically, the unread messages refer to messages and notifications that have been sent by various applications or the system, previously received or newly received on the mobile terminal, and have not been read by a user. The unread messages include but are not limited to: short messages, system notification messages, third-party social media (e.g., WeChat, QQ, Facebook, Twitter) messages, application notifications and messages, etc.

Furthermore, after the unread messages on the mobile terminal have been obtained, contents of the unread messages, applications that sent the messages, users who sent the messages, and other related information can be read and stored in a message dynamic array. According to a preset filtering rule, the messages in the message dynamic array are filtered, and a message that does not meet the filtering rule is removed from the message dynamic array, so that only messages that the user are interested in and cares about are retained in the message dynamic array, which reduces interference caused by redundant messages and spam messages to the user. For example, the filtering rule may be set to exclude display of system notifications, messages from a certain WeChat group, messages from entertainment applications such as TikTok, etc.

Optionally, when the mobile terminal is in a lock screen state or a sleep state, it may be detected regularly or irregularly whether any new unread message has been received. When a new unread message has been received, the new unread message may be stored in the message dynamic array. It is also possible that the unread message will not be obtained in the sleep state when the display screen of the mobile terminal is dark, and the message may be obtained when the display screen of the mobile terminal is waked up through the user pressing a power button or clicking the screen of the mobile terminal, which saves power consumption of the mobile terminal.

It should be noted that the mobile terminal can be any device with communication functions, such as, a mobile phone, a tablet, a personal digital assistant, a mobile Internet device, a wearable device, etc.

The message display module 610 is configured to display the one or more unread messages on a lock screen interface of the mobile terminal.

Specifically, when the mobile terminal is in the lock screen state, the contents of the obtained unread message on the mobile terminal are read and displayed on the lock screen interface. In order to keep the messages confidential and safe, it may be set that only a small first part of an unread message is displayed in the lock screen state, and the remaining part thereof is represented by an ellipsis.

In some embodiments, the message display module 610 displays the obtained unread messages in a bullet chatting manner on the lock screen interface. There may be a variety of display modes for controlling the display of the messages according to such as movement directions, display array forms, alignment modes, etc. The movement directions may include from top to bottom, from left to right, clockwise, etc. The display array forms may include a rectangle form, a screen edge form, etc. The alignment modes may include aligned mode, misaligned mode, random mode, etc. By setting the variety of display modes, the user of the mobile terminal may choose a suitable display mode according to the user's own operating habits and browsing habits.

Furthermore, the set display rule may include for example: setting different display fonts and display colours for messages from different applications; displaying different avatars for messages sent by different users; setting different movement modes and movement speeds for messages from different applications according to the respective usage frequencies of the applications. For example, a content of a message sent by an application that the user uses frequently scrolls slower, and a content of a message sent by an application that the user uses occasionally scrolls faster. The messages may also be categorized as, for example, a work message, an entertainment message, a shopping message, etc., and different display modes may be used for different categories of messages. According to the above display rules, the unread messages are displayed on the lock screen interface in different display modes, so that the user has a clear overview of the messages, and it is convenient for the user to focus more on important message(s).

The unlocking module 620 is configured to trigger an unlocked state of the mobile terminal.

Specifically, for the security of the user's information and privacy, the messages displayed on the lock screen interface cannot be operated before the lock screen interface is unlocked. The unlocked state can be triggered by sliding gesture recognition, password recognition, facial recognition, voice recognition, fingerprint recognition, etc. In other words, only after the user is identified as the owner of the mobile terminal, can the user view the details of the messages and notifications, and perform operations such as replying to the messages and identifying the messages.

The operation response module 630 is configured to perform a corresponding response operation on one of the unread messages on the lock screen interface according to an operation instruction.

Specifically, when the mobile terminal is in the unlocked state, different operations may be performed on the unread message, such as, viewing the details of the message (or notification), replying to the message, identifying the message, marking the message as read, etc. For example, after the user has clicked the unread message, the message may be displayed as read or an edit box may be displayed for reply to the message directly, or the unread message may be dragged to an edge of the screen to mark the message as read. It should be noted that the operations on the unread message and the corresponding response operations may be diverse and may be changed according to the user's operating habits and the system settings of the mobile terminal.

Specifically, in some embodiments, for the specific function of each module of the above lock screen interface message processing device, one can refer to the corresponding description on the above lock screen interface message processing method, and will not be repeated here.

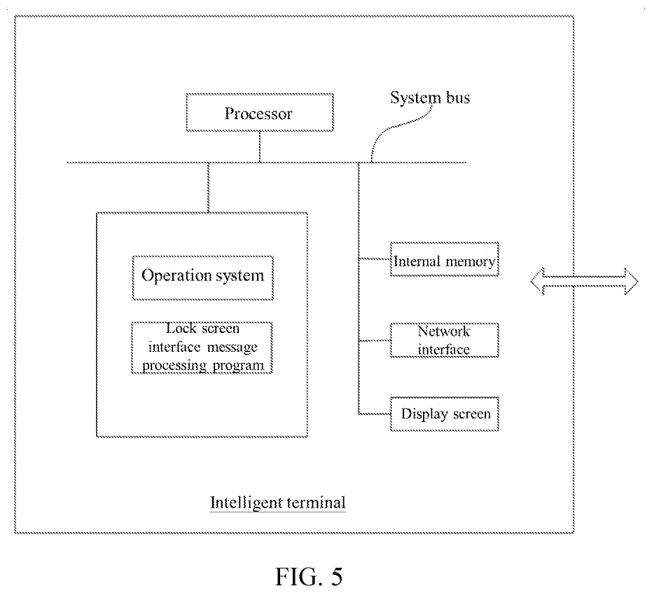

Based on the above embodiments, the present disclosure further provides an intelligent terminal, a schematic block diagram of which can be as shown in FIG. 5. The intelligent terminal includes a processor, a memory, a network interface, and a display screen connected through a system bus. The processor of the intelligent terminal is used to provide computing and control functions. The memory of the intelligent terminal includes a non-volatile storage medium and an internal memory. The non-volatile storage medium stores an operation system and a lock screen interface message processing program. The internal memory provides an environment for the operation of the operation system and the lock screen message processing program in the non-volatile storage medium. The network interface of the intelligent terminal is used to communicate with external terminals through network connections. When the lock screen interface message processing program is executed by the processor, the operations of any of the above lock screen interface message processing method(s) are implemented. The display screen of the intelligent terminal may be a liquid crystal display screen or an electronic ink display screen.

Those skilled in the art can understand that the schematic block diagram shown in FIG. 5 is only a block diagram of a partial structure related to the solutions of the present disclosure, and does not constitute a limitation on the intelligent terminal to which the solutions of the present disclosure is applied. The specific intelligent terminal may include more or fewer components than shown in the figure, or certain components thereof may be combined, or the specific intelligent terminal may have a different arrangement of the components.

In some embodiments, an intelligent terminal is provided. The intelligent terminal includes a memory, a processor, and a lock screen interface message processing program stored in the memory and executable on the processor. When executed by the above processor, the lock screen interface message processing program implements the following operation instructions:
obtaining one or more unread messages on a mobile terminal;
displaying the one or more unread messages on a lock screen interface of the mobile terminal; and
performing, after an unlocked state of the mobile terminal is triggered, a corresponding response operation on an unread message of the one or more unread messages on the lock screen interface according to an operation instruction.

Some embodiments of the present disclosure further provide a non-transitory computer-readable storage medium. The non-transitory computer-readable storage medium stores a lock screen interface message processing program. When executed by a processor, the above lock screen interface message processing program may implement operations of any of the lock screen interface message processing methods provided by the embodiments of the present disclosure.

It should be understood that a sequence number of each operation in the above embodiments does not mean an execution order. The execution order of each process should be determined by its function and internal logic, and should not constitute any limitation on the implementation process of the embodiments of the present disclosure.

Those skilled in the art can clearly understand that, for the convenience and simplicity of description, the division of the above functional units and modules is merely used as an example. In actual applications, the above functions can be allocated to different functional units and modules according to needs. That is, an internal structure of the above device may be divided into different functional units or modules to complete all or part of the functions described above. The functional units and modules in the embodiments can be integrated into one processing unit, or each unit can exist physically alone, or two or more units can be integrated into one unit. The above-mentioned integrated unit can be hardware-based, or can be implemented in the form of software functional units. In addition, a specific name of each functional unit and module is only for the convenience of distinguishing from each other and is not used to limit the scope of protection of the present disclosure. For the specific working processes of the units and modules in the above system, please refer to the corresponding processes in the foregoing method embodiments, and will not be described again here.

In the above embodiments, each embodiment is described with its own emphasis. For parts that are not detailed or documented in a certain embodiment, please refer to the relevant descriptions of other embodiments.

Those of ordinary skill in the art can appreciate that the units and operations in an algorithm described in the embodiments disclosed herein can be implemented with electronic hardware or a combination of computer software and electronic hardware. Whether these functions are performed in hardware or software depends on a specific application and a design constraint of a technical solution. Skilled artisans may implement the described functions using different methods for different specific applications, but such implementations should not be considered beyond the scope of present disclosure.

In the embodiments provided in present disclosure, it should be understood that the disclosed devices/terminal devices and methods can be implemented in other ways. For example, the devices/terminal devices embodiments described above are only illustrative. For example, the division of the above modules or units is only a logical function division. In actual implementation, there may be other division ways. For example, multiple components may be combined or may be integrated into another system, or some features may be ignored or not implemented.

When implemented in the form of software functional units and sold or used as independent products, the above-mentioned integrated modules/units can be stored in a computer-readable storage medium. Based on this understanding, the present disclosure can implement all or part of the processes in the methods of the above embodiments by instructing relevant hardware through a computer program. The above computer program can be stored in a computer-readable storage medium. When executed by the processor, the computer program may implement the operations of each of the above method embodiments. The above-mentioned computer program includes computer program code. The above-mentioned computer program code may be in the form of source code, object code, an executable file, or some intermediate form, etc. The above computer-readable medium may include: any entity or device, recording medium, USB flash drive, mobile hard drive, magnetic disk, optical disk, computer memory, Read-Only Memory (ROM), and Random Access Memory (RAM), which may carry the above computer program code, electrical carrier signals, telecommunications signals, and software distribution medium, etc. It should be noted that the content contained in the above computer-readable storage medium can be appropriately increased or decreased according to the requirements of legislation and patent practice in the jurisdiction.

The above-described embodiments are only used to illustrate the technical solutions of the present disclosure, but are not intended to limit it. Although the present disclosure has been described in detail with reference to the foregoing embodiments, it will be understood by those of ordinary skill in the art that it is still possible to modify the technical solutions recorded in the foregoing embodiments, or to equivalently replace some of the technical features therein. However, these modifications or substitutions do not deviate the essence of the corresponding technical solutions from the spirit and scope of the technical solutions of the embodiments of present disclosure, and should still be included in the protection scope of present disclosure.

What is claimed is:

1. A lock screen interface message processing method, comprising:
obtaining one or more unread messages on a mobile terminal;
displaying the one or more unread messages on a lock screen interface of the mobile terminal; and
performing, after an unlocked state of the mobile terminal is triggered, a corresponding response operation on an unread message of the one or more unread messages on the lock screen interface according to an operation instruction.

2. The lock screen interface message processing method according to claim 1, wherein the displaying of the one or more unread messages on the lock screen interface of the mobile terminal comprises:
obtaining, for each unread message of the one or more unread messages, a display mode corresponding to the unread message according to a set display rule; and
displaying the unread message on the lock screen interface based on the corresponding display mode.

3. The lock screen interface message processing method according to claim 2, wherein the display mode corresponding to the unread message comprises at least one of a movement speed and a movement mode of the unread message, and the obtaining of the display mode corresponding to the unread message according to the set display rule comprises:
obtaining a source of the unread message; and
obtaining the at least one of the movement speed and the movement mode of the unread message from the display rule based on the source.

4. The lock screen interface message processing method according to claim 3, wherein the performing of the corresponding response operation on the unread message on the lock screen interface according to the operation instruction after the unlocked state of the mobile terminal is triggered comprises:
displaying, after the unlocked state of the mobile terminal is triggered, the unread message on the lock screen interface in one of a horizontal layout form and a vertical layout form; and
performing the corresponding response operation on the unread message on the lock screen interface according to the operation instruction.

5. The lock screen interface message processing method according to claim 2, wherein the display mode corresponding to the unread message comprises a display font and a display colour of the unread message, and the method further comprises:
obtaining display fonts and display colours corresponding to messages of applications on the mobile terminal, wherein the messages of different applications correspond to different display fonts and different display colours; and
setting the display rule based on the display fonts and the display colours corresponding to the messages of the applications on the mobile terminal.

6. The lock screen interface message processing method according to claim 2, wherein the display mode corresponding to the unread message comprises an avatar of a user who sends the unread message, and the method further comprises:
obtaining avatars of users sending messages to the mobile terminal, wherein users corresponding to different messages correspond to different avatars; and
setting the display rule based on the avatars of the users sending the messages.

7. The lock screen interface message processing method according to claim 2, wherein the display mode corresponding to the unread message comprises a display position, a display colour, a movement mode, and a movement speed of the unread message, and the method further comprises:
obtaining, for each application of applications on the mobile terminal, a usage frequency of the application;
determining a display position, a display colour, a movement mode, and a movement speed of a message of the application; and
setting the display rule based on the display position, the display colour, the movement mode, and the movement speed of the message of the application.

8. The lock screen interface message processing method according to claim 2, further comprising:
obtaining a category of a message on the mobile terminal;
determining a display mode corresponding to the category of the message; and
setting the display rule based on the display mode.

9. The lock screen interface message processing method according to claim 1, further comprising:
obtaining a set filtering rule; and
filtering the one or more unread messages based on the filtering rule.

10. The lock screen interface message processing method according to claim 9, further comprising:
obtaining a source and a category of a message on the mobile terminal; and
setting the filtering rule based on the source and category of the message.

11. The lock screen interface message processing method according to claim 1, wherein the displaying of the one or more unread messages on the lock screen interface of the mobile terminal comprises:
obtaining an unread message array based on the one or more unread messages; and
displaying the unread message array in a bullet chatting manner on the lock screen interface.

12. The lock screen interface message processing method according to claim 11, wherein the performing of the corresponding response operation on the unread message on the lock screen interface according to the operation instruction comprises:
obtaining a selected unread message from the one or more unread messages on the lock screen interface;
marking the selected unread message on the lock screen interface as read;
displaying, when the selected unread message requires a reply, a reply area on the lock screen interface;
obtaining a reply content in the reply area, and sending the reply content to an application corresponding to the selected unread message; and
removing the selected unread message from the unread message array.

13. The lock screen interface message processing method according to claim 11, wherein the performing of the corresponding response operation on the unread message on the lock screen interface according to the operation instruction comprises:
obtaining a plurality of selected unread messages from the unread messages on the lock screen interface;
marking the plurality of selected unread messages on the lock screen interface as read; and
removing the plurality of selected unread messages from the unread message array.

14. The lock screen interface message processing method according to claim 13, wherein the marking of the plurality of selected unread messages on the lock screen interface as read comprises:
marking, in response to a drag operation for dragging the plurality of selected unread messages to an edge of a screen of the mobile terminal, the unread messages corresponding to the drag operation as read.

15. The lock screen interface message processing method according to claim 13, wherein the obtaining of the plurality of selected unread messages from the one or more unread messages on the lock screen interface comprises:
determining, in response to a click operation on an unread message of the unread messages, the unread message corresponding to the click operation as one of the plurality of selected unread messages on the lock screen interface; and
the marking of the plurality of selected unread messages on the lock screen interface as read comprises:
marking, in response to a click operation on a close button on the lock screen interface, the selected unread messages on the lock screen interface as read.

16. The lock screen interface message processing method according to claim 1, wherein the obtaining of the one or more unread messages on the mobile terminal comprises:
obtaining a luminescence state of a screen of the mobile terminal; and
obtaining, when the luminescence state indicates that the screen is on, the one or more unread messages.

17. The lock screen interface message processing method according to claim 1, wherein the displaying of the one or more unread messages on the lock screen interface of the mobile terminal comprises:
obtaining part of a message content of an unread message of the one or more unread messages; and
displaying the unread message on the lock screen interface of the mobile terminal by displaying a combination of the part of the message content and an ellipsis.

18. An intelligent terminal comprising a memory, a processor, and a lock screen interface message processing program stored in the memory and executable on the processor, wherein when executed by the processor, the lock screen interface message processing program implements a lock screen interface message processing method comprising:
obtaining one or more unread messages on a mobile terminal;
displaying the one or more unread messages on a lock screen interface of the mobile terminal; and
performing, after an unlocked state of the mobile terminal is triggered, a corresponding response operation on an unread message of the one or more unread messages on the lock screen interface according to an operation instruction.

19. A non-transitory computer-readable storage medium storing a lock screen interface message processing program, wherein when executed by a processor, the lock screen interface message processing program implements a lock screen interface message processing method comprising:
obtaining one or more unread messages on a mobile terminal;
displaying the one or more unread messages on a lock screen interface of the mobile terminal; and
performing, after an unlocked state of the mobile terminal is triggered, a corresponding response operation on an unread message of the one or more unread messages on the lock screen interface according to an operation instruction.

20. The non-transitory computer-readable storage medium according to claim 19, wherein the displaying of the one or more unread messages on the lock screen interface of the mobile terminal comprises:
obtaining, for each unread message of the one or more unread messages, a display mode corresponding to the unread message according to a set display rule; and
displaying the unread message on the lock screen interface based on the corresponding display mode.
